(19) United States
(12) Patent Application Publication
(10) Pub. No.: US 2003/0046447 A1
(43) Pub. Date: Mar. 6, 2003

(54) Device-related software installation

(76) Inventors: Konstantin Kouperchliak, Kfar Saba (IL); Alexander Aronson, Netanya (IL)

Correspondence Address: WELSH & KATZ, LTD., 22nd Floor, 120 South Riverside Plaza, Chicago, IL, 60606, US

(21) Appl. No.: 10/209,785

(22) Filed: Jul. 31, 2002

Related U.S. Application Data
(60) Provisional application No. 60/310,020, filed on Jul. 31, 2001.

(51) Int. Cl. G06F 13/10; G06F 9/445; G06F 3/00

(52) U.S. Cl. 709/321; 717/174; 710/8

(57) ABSTRACT

A peripheral device for a computer, having stored therein one or more software items for example device-related software (DRS) including software drivers for permitting interaction between the device and the computer The peripheral device checks whether a device-related software is already installed and, if not uploads one or more appropriate device-related software items to the computer for the proper installation and operation of the peripheral device by the computer

### FIELD OF THE INVENTION

The present invention relates to device-related software (hereinafter “DRS”) installation and more particularly but not exclusively to the installation of device-related software for universal serial bus (USB) devices

### BACKGROUND OF THE INVENTION

After serial and parallel interfaces, the USB interface is fast becoming popular as a means of connecting peripheral devices to computers The USB interface is covered by an International standard and provides high speed communication It is also particularly preferred in that it is specially designed to support plug and play connections without needing to open up the PC, for example to insert an adapter card.

USB devices, that is to say the peripheral devices designed to be connected to a computer via a USB interface, generally require a software driver that operates in association with the operating system of the computer. The peripheral device manufacturers ,generally prepare such a software driver and then make it available to the operating system providers so that it can be included with the operating system. Then, when the device is first connected to the computer via the USB interface, the operating system identifies the device and installs the appropriate driver.

In general such an arrangement, known as “plug & play”, is advantageous to the user since device installation is automatic. However, device manufacturers are reliant on the operating system providers and furthermore, an operating system that predates a given device will not have the appropriate driver. Lack of the appropriate driver can be partly overcome in that operating systems also include generic drivers that can be selected in the absence of anything more specific. Nevertheless ,generic drivers cannot be guaranteed to take advantage of all of the features of the peripheral device Furthermore, operating system providers provide regular driver updates to their operating system which are distributed over the internet or in other ,ways. and the manufacturer may also supply a driver disk with the device. This latter solution however defeats the whole aim of “plug & play”

### SUMMARY OF THE INVENTION

It is therefore an object of a preferred embodiment of the present invention to ensure that specific device-related software, such as a driver, is always available with the peripheral device.

There is thus provided, in accordance with a preferred embodiment of the present invention, apparatus for automatic installation into a computer host, of a selectable functional device from among a population of functional devices connectable to a computer host via an interface, each functional device having a primary function, the computer host having a computer operating system comprising a mass storage device driver with an autoplay feature operative, as long as an encountered device is recognized as a mass storage device, to automatically port information contents of the encountered device onto the operating system, the apparatus including a mass storage device emulator operative, until it is deactivated, to cause the mass storage device driver to recognize the selectable functional device as a mass storage device, thereby causing the information contents of the selectable functional device to be automatically ported onto the operating system until the mass storage device emulator is deactivated, a primary function software loader and a switch operative to deactivate said mass storage device emulator as soon as the porting of the primary function loader onto the operating system has been completed, wherein the primary function software loader, once ported onto the operating system is operative to load primary function software which performs the primary function. from the USB device onto the computer host

Also provided is a mass storage device emulator for automatic installation in a host computer having an operating system, of an electronic functional device having functional software which resides thereon, the mass storage device emulator residing on the functional device and being operative in conjunction with an operating system having a mass storage device driver with an autoplay feature, the emulator activating the loading functionality of the mass storage device driver thereby to load the functional software onto the operating system

Further in accordance with a preferred embodiment of the present invention, the interface comprises a USB interface.

In accordance with a preferred embodiment of the present invention there is thus provided a peripheral device operable to identify whether specific device-related software is available for installation or is installed on a computer to which it is connected, and in the event that such specific device-related software is not installed or is not available for installation, is operable to install device-related software stored in its own memory onto the computer

In accordance with a first preferred embodiment of the present invention there is provided a peripheral device for a computer, having stored therein device-related software for permitting interaction between the device and the computer, wherein the peripheral device is operable to upload the device related software to the computer for installation of the peripheral device by the computer. Preferably, the device-related software comprises a device driver It may also comprise one or more configuration files and other software necessary for smooth running of the peripheral device under the operating system Typically, the device-related software comprises a plurality of software items, each of the items being appropriate for a different operating system or a different version of an operating system.

In one preferred embodiment the peripheral is operable as a Mass Storage Device (hereinafter MSD) emulator which includes an AutoPlay feature (hereinafler AX) which automatically starts a specific application on media upon insertion Such a device can be a CD device using the AutoRun feature. Thus the device may have a primary function embodied in a functional unit and a switch for switching between the mass storage device emulator and the functional unit.

Preferably the peripheral is switched as a CD device emulator upon starting of the computer

One preferred embodiment is operable to recognize a device-related software identifier string relating to one of the software items stored therein and, in response thereto to switch to the functional unit.

Preferably. the mass storage device emulator is operable to auto load a program to the computer to obtain identification data of the operating system used by the computer

According to a preferred embodiment of the present invention, a plurality of device-related software files are stored and the system of the present invention selects therefrom an appropriate device-related software file or files for uploading, preferably based on an identification of an operating system installed on the computer.

Embodiments of the present invention particularly relate to peripheral devices designed to be connected to a computer via a USB interface

According to a second aspect of the present invention there is provided a device for connecting to a computer having an operating system and requiring a device-related software item suitable for the device and the operating system, to be installed on the computer to co-operate with the operating system to drive the device, characterized by having a memory in which at least one suitable device-related software item is stored, and an uploading controller for uploading the device-related software item from the device to the computer

The device is preferably a USB device and preferably the uploading controller is operable to recognize a device-related software identification string from the computer indicating that a suitable device-related software item is already installed on the computer

Preferably, the uploading controller is operable to recognize a device-related software are identification string from the computer indicating that a suitable device-related software item is already installed on the computer

Preferably, the uploading controller is operable to upload the suitable device-related software item to the computer only when no the device-related software identification string is recognized

Preferably the device stores plurality of device-related software items each suitable for a different operating system, and the uploading controller is operable to interrogate the computer to find out what operating system is in use and thereby to select a device-related software item suitable for the operating system.

According to a third aspect of the present invention there is provided a method of installing a peripheral device requiring a device-related software item, onto a computer using an operating system having an automatic installation procedure, comprising the steps of storing the device-related software item in the peripheral device, determining whether the device-related software item is operative on the computer, uploading the device-related software item from the peripheral device to the computer if the device-related software item is not operative on the computer, and allowing the operating system to detect the device and carry out its automatic installation procedure using the uploaded device-related software item

Preferably, the peripheral device has a plurality of device-related software items stored therein each one suitable for a different operating system or version of an operating system, the step of uploading comprising the steps of sending a command from the peripheral device to the computer requesting identification of the operating system, selecting one device-related software item from the plurality thereof, which is suitable for the operating system so identified, and uploading the selected device-related software item.

Preferably, the command requesting identification of the operating system is done using the AutoPlay application that automatically runs when emulating a mass storage device

According to a fourth aspect of the present invention there is provided a peripheral device for a computer comprising a mass storage device emulator, the device being operable to be switched between a first mode of standard operation as a peripheral device and a second mode of operation which employs the mass storage device emulator

Preferably, the device is a USB device

Preferably, the device comprises one or more device-related software files and is operable in the second mode of operation to determine whether a device-related software item corresponding to the device is installed on a computer to which it is attached and, if not, to upload one of the device-related software files to the computer for installation

### BRIEF DESCRIPTION OF THE DRAWINGS

For a better understanding of the invention and to show how the same may be carried into effect reference is now made, purely by way of example, to the accompanying drawings, in which.

FIG. 1 is a simplified diagram showing a computer having peripheral devices connected thereto in accordance with a first preferred embodiment of the present invention,

FIG. 2 is a simplified block diagram showing the internal construction of a peripheral device in accordance with another preferred embodiment of the present invention and

FIG. 3 is a simplified flow chart showing the operation of the peripheral device of FIG. 2 in accordance with a preferred embodiment of the present invention

### DESCRIPTION OF THE PREFERRED EMBODIMENTS

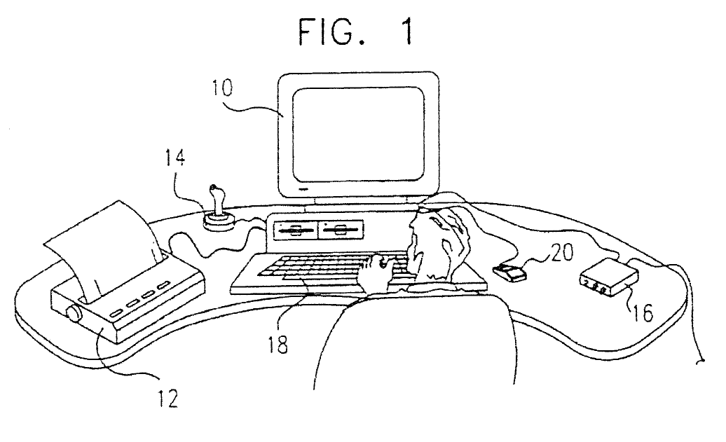

Reference is now made to FIG. 1, which shows a computer 10 to which are connected peripheral devices including a printer 12, a joystick 14 and a modem 16. Also shown are a keyboard 18 and a mouse 20. A network connection is not shown but may also be present At least one of the peripherals 12, 14, 16, 18 and 20 is a USB device and is connected via a USB interface. At least some of the peripheral devices 12, 14, 16, 18 and 20 requires device-related software which typically comprises a software program that interacts with the operating system to operate the peripheral device.

Upon attachment of a new peripheral device to the computer, the operating system is generally operable to identify the peripheral device, following which it searches through its collection of device-related software items for the most appropriate software for the identified peripheral device.

If no suitable device-related software is found the user may be invited to insert a disk containing the device-related software If a suitable device-related software is found the user may be asked to confirm that the device-related software is suitable or to choose another device-related software, and, once a suitable device-related software is settled on, the operating system installs the device-related software and sets up the peripheral device for use

In accordance with a preferred embodiment of the present invention the peripheral device being attached to the computer itself determines whether the required device-related software is installed on the operating system. If so the peripheral device operates as normal If, however, the required device-related software is not installed on the operating system then the peripheral device uploads suitable device-related software from its own memory to the computer as will be described in more detail below Installation man then proceed in the usual manner, using the uploaded device-related software

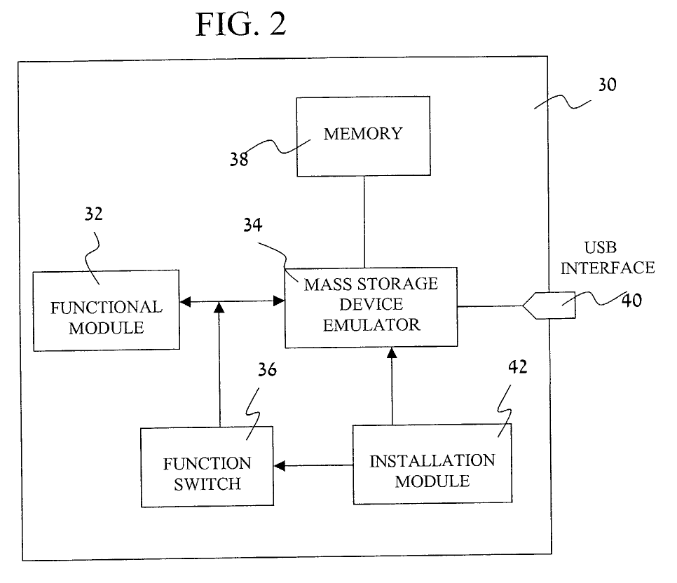

Reference is now made to FIG. 2 which is a simplified block diagram showing the internal construction of a peripheral device such as a USB device 30 in accordance with a preferred embodiment of the present invention A functional module 32 preferably comprises all the functionality of the normal operation of the USB device under control of the device-related software A mass storage device emulator 34 with an AutoPlay feature is also provided, which provides an interface with the computer that allows the USB device 30 to appear to the computer as if it is a mass storage device such as a CD device A function switch 36 is operable to switch between the functional module and the mass storage device emulator.

A memory 38 preferably a non-volatile memory such as ROM, PROM or flash memory, is connected to the mass storage device emulator 34 Within the memory is preferably stored a series of device-related software items, each one appropriate to a different operating system or version thereof In addition there may be provided one or more configuration files allowing the peripheral device to be configured in different ways. either selectable by the user or by the software

The peripheral device is preferably connectable to the computer via a USB interface 40

A software installation module 42 preferably comprises a control program for the installation procedure. It is shown herein as a separate block for purposes of clarity although the skilled person will appreciate that in fact it can be implemented in various ways

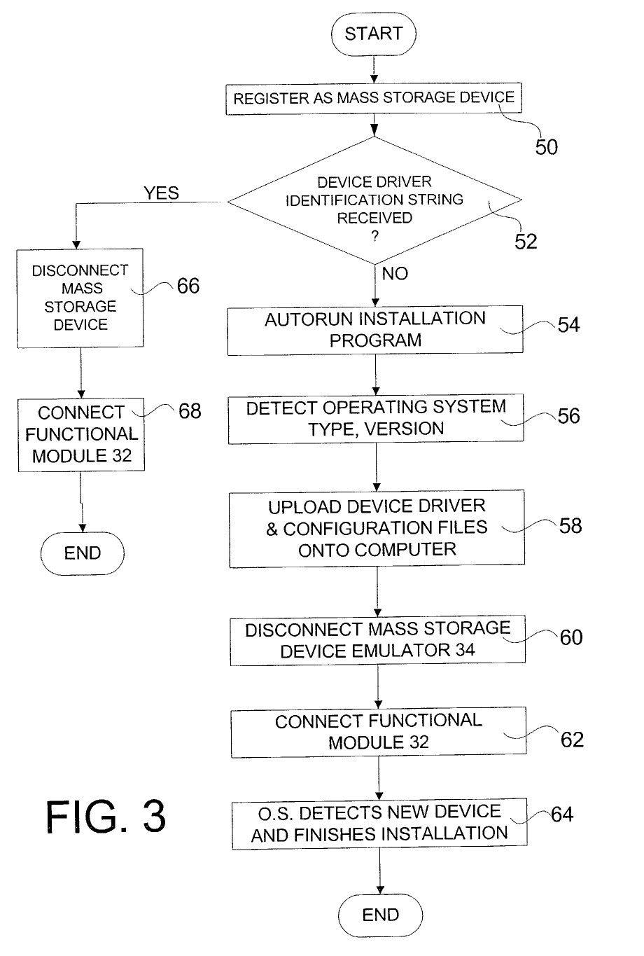

The installation procedure of a peripheral device according to a preferred embodiment of the present invention will now be described with reference to FIG. 3, which is a generalized flow diagram showing operation of the peripheral device upon starting operation thereof, in accordance with a preferred embodiment of the present invention

Upon starting the peripheral device, which generally occurs when the peripheral device is plugged in, the function switch 36 automatically switches the peripheral device over to the mass storage device emulator. The peripheral device therefore initially registers with the operating system as a mass storage device such as a CD device (step 50). The device-related software, if installed, either automatically sends out device-related software identification strings, or replies to the peripheral devices request for the identification strings, with the intention of obtaining the acknowledgement of the requesting device Thus strings received are intercepted at the mass storage device emulator port and read If (step 52) the device-related software identification string corresponding to the peripheral device of the invention is identified, then the peripheral device knows that the appropriate device-related software is installed on the computer The mass storage device emulator 34 is disconnected (step 66) and the functional module 32 is connected in its place (step 68) for normal operation of the peripheral device

A time out or other condition may be set to define a window for receiving the identification string. If the device-related software identification string is not identified within the window then the peripheral device begins an automatic installation procedure (step 54) as follows First of all the mass storage device AutoPlay application will run and preferably check the operating system to obtain the identity of the operating system (step 56) In response the operating system sends one or more data strings indicating its type and its version number The received data strings are used to select the appropriate device-related software for the operating system type and version number thus identified, and the appropriate device-related software is uploaded to the computer The AutoPlay application uploads the device-related software or the installation program chosen and installs the device-related software (step 58) This is followed by a step of disconnecting the mass storage device emulator 34 (step 60) and connecting the functional module 32 in its place (step 62) so that the peripheral device no longer resembles a mass storage device to the computer

Now the operating system is operable to detect the functional module 32 as a new peripheral device in the normal way (step 64). The correct device-related software is located on the computer in a place where the operating system may expect to find it, and thus a standard “plug & play” installation procedure can be carried out to install the new peripheral device. No intervention on the part of the user is required to find the correct device-related software

In the foregoing description, the terms “device-related software” or “DRS” have been used to describe a software package which enables a host to operate in conjunction with a particular device. Each such package may include driver programs and configuration flies In the specification and claims, the term “software item” is used to refer to a single program or software module within a device-related software package. The term “Functional software” is generally synonymous with “device-related software” and refers to the software which enables the device to carry out its primary function

It is appreciated that various features of the invention which are, for clarity described in the contexts of separate embodiments may also be provided in combination in a single embodiment Conversely, various features of the invention which are for brevity, described in the context of a single embodiment may also be provided separately or in any suitable subcombination

It is appreciated that the software components of the present invention may if desired, be implemented in ROM (read-only memory) form The software components may, generally, be implemented in hardware, if desired, using conventional techniques

It will be appreciated by persons skilled in the art that the present invention is not limited to what has been particularly shown and described hereinabove Rather, the scope of the present invention includes both combinations and subcombinations of the various features described hereinabove as well as variations and modifications thereof which would occur to persons skilled in the art upon reading the foregoing description and which are not in the prior art.

1. Apparatus for automatic installation into a computer host, of a selectable functional de ice from among a population of functional devices connectable to a computer host via an interface. each functional device having a primary function,
the computer host having a computer operating system comprising a mass storage device driver with an autoplay feature operative, as long as an encountered device is recognized as a mass storage device, to automatically port information contents of the encountered device onto the operating system:
the apparatus comprising,
a mass storage device emulator operative, until it is deactivated, to cause the mass storage device driver to recognize the selectable functional device as a mass storage device, thereby causing the information contents of the selectable functional device to be automatically ported onto the operating system until the mass storage device emulator is deactivated;
a primary function software loader; and
a switch operative to deactivate said mass storage device emulator as soon as the porting of said primary function loader onto the operating system has been completed,
wherein said primary function software loader, once ported onto the operating system, is operative to load primary function software which performs said primary function from the USB device onto the computer host.

2. A mass storage device emulator for automatic installation in a host computer having an operating system, of an electronic functional device having functional software which resides thereon.
the mass storage device emulator residing on the functional device and being operative in conjunction with an operating system having a mass storage device driver with an autoplay feature, the emulator activating the loading functionality of the mass storage device driver thereby to load the functional software onto the operating system

3. Apparatus according to claim 1 wherein said interface comprises a USB interface

4. A peripheral device for a computer. having stored therein device-related software for permitting interaction between the device and the computer, wherein said peripheral device comprises a mass storage device emulator and is operable to upload the device related software to said computer for installation of said peripheral device by said computer, wherein the device-related software comprises a device driver, and wherein said device-related software comprises a plurality of software items, each of said items being appropriate for a different operating system or a different version of an operating system

5. A peripheral device according to claim 4 having a primary function embodied in a functional unit and further comprising a switch for switching between the Mass Storage device emulator and the functional unit.

6. A peripheral device according to claim 5, which is switched as a Mass Storage device emulator upon starting of the computer

7. A peripheral device according to claim 5, operable to recognize a device-related software identifier string relating to one of the software items stored therein and, in response to the string, to switch to the functional unit.

8. A peripheral device according to claim 6, operable to recognize a device-related software identifier string relating to one of the software items stored therein and, in response to the string, to switch to the functional unit.

9. A peripheral device according to claim 7, wherein said Mass Storage Device emulator is operable to AutoRun an application program on the computer to obtain identification data of an operating system used by the computer.

10. A peripheral device according to claim 4, having stored therein a plurality of device-related software files and being operable to select therefrom at least one device-related software file suitable for uploading.

11. A peripheral device according to claim 9, having stored therein a plurality of device-related software files and being operable to select at least one device-related software file suitable for uploading.

12. A peripheral device according to claim 10. operable to select said at least one device-related software file based on an identification of an operating system installed on said computer

13. A peripheral device according to claim 4, designed to be connected to a computer via a USB interface

14. A device for connecting to a computer having an operating system and being operable in conjunction with a device-related software item suitable for said device and said operating system, to be installed on said computer to co-operate with said operating system to drive said device, the device having a memory in which at least one suitable device-related software item is stored, and an uploading controller for uploading said device-related software item from said device to said computer.

15. A device according to claim 14, which is a USB device

16. A device according to claim 14, wherein the uploading controller is operable to recognize a device-related software identification string from the computer indicating that a suitable device-related software item is already installed on the computer

17. A device according to claim 15, wherein the uploading controller is operable to recognize a device-related software identification string from the computer indicating that a suitable device-related software item is already installed on the computer

18. A device according to claim 16, wherein the uploading controller is operable to upload said suitable device-related software item to said computer only when no said device-related software identification string is recognized

19. A device according to claim 14, comprising a plurality of device-related software items each suitable for a different operating system, wherein said uploading controller is operable to interrogate said computer to find out what operating system is in use and thereby to select a device-related software item suitable for said operating system

20. A device according to claim 18, comprising a plurality of device-related software items each suitable for a different operating system, wherein said uploading controller is operable to interrogate said computer to find out what operating system is in use and thereby to select a device-related software item suitable for said operating system

21. A method of installing a peripheral device operative in conjunction with a device-related software item, onto a computer using an operating system having an automatic installation procedure. the method comprising
storing the device-related software item in the peripheral device,
determining whether the device-related software item is operative on the computer,
if the device-related software item is not operative on the computer then uploading the device-related software item from the peripheral device to the computer, and
allowing the operating system to detect the device and carry out its automatic installation procedure using the uploaded device-related software item,
wherein said peripheral device has a plurality of device-related software items stored therein, each one suitable for a different operating system or version of an operating system said step of uploading comprising the steps of,
sending a command from the peripheral device to the computer requesting identification of the operating system,
selecting one device-related software item from said plurality thereof, which is suitable for the operating system identified by the sending step, and
uploading said selected device-related software item,
wherein said command requesting identification of the operating system is sent by an AutoRun application

22. A peripheral device for a computer comprising a Mass Storage Device emulator and operable to be switched between a first mode of standard operation as a peripheral device and a second mode of operation which employs said Mass Storage Device emulator

23. A peripheral device according to claim 22, which is a USB device.

24. A peripheral device according to claim 22, further comprising at least one device-related software files and being operable in said second mode of operation to determine whether a device-related software item corresponding to said device is installed on a computer to which the peripheral device is attached and, if not, to upload one of said device-related software files to said computer for installation

25. A peripheral device according to claim 23, further comprising at least one device-related software files and being operable in said second mode of operation to determine whether a given device-related software item corresponding to said device is installed on a computer to which the peripheral device is attached and, if not, to upload one of said device-related software files to said computer for installation
